(19) United States
(12) Patent Application Publication
(10) Pub. No.: US 2010/0112834 A1
(43) Pub. Date: May 6, 2010

(54) MANUFACTURING PROCESS FOR CONDUCTIVE TERMINALS AND ELECTRICAL CONNECTOR HAVING THE TERMINALS

(75) Inventors: Kuan-Wu CHEN, Taoyuan City (TW); Zhi-Fu Zhou, Jiangsu (CN)

Correspondence Address: MORRISON & FOERSTER LLP, 755 PAGE MILL RD, PALO ALTO, CA, 94304-1018, US

(73) Assignees: BELLWETHER ELECTRONIC CORP., Taoyuan City (TW); Kunshan Jiahua Electronics Co., Ltd., Suzhou (CN)

(21) Appl. No.: 12/607,785

(22) Filed: Oct. 28, 2009

(30) Foreign Application Priority Data
Oct. 31, 2008 (TW) 097141988

(51) Int. Cl. H01R 12/00; H01R 43/04

(52) U.S. Cl. 439/78; 29/882

(57) ABSTRACT

A manufacturing process for a plurality of conductive terminals, comprising the steps of:

(1) punching a flat metallic plate to form a carrier and a plurality of spaced-apart terminal bodies, and blanking each of the terminal bodies to form an uneven surface, so that the uneven surface serves as a wiping unit;

(2) bending each of the terminal bodies to form a curved contact segment, a resilient segment, a fixed segment, and a connecting segment, such that the uneven surface is located at the contact segment;

(3) assembling the bent terminal bodies to an insulating housing; and

(4) cutting and removing the carrier from the terminal bodies so that the terminal bodies disposed on the insulating housing constitute the conductive terminals.

### CROSS-REFERENCE TO RELATED APPLICATION

This application claims priority of Taiwanese Application No. 097141988, filed on Oct. 31, 2008.

### BACKGROUND OF THE INVENTION

1. Field of the Invention

This invention relates to a manufacturing process for a plurality of conductive terminals, and more particularly to a process for manufacturing a plurality of conductive terminals of an electrical connector connectable with an electronic card.

2. Description of the Related Art

U.S. Pat. No. 6,722,906 discloses an electrical connector including a plurality of conductive terminals each having a contact segment. When an electronic card is assembled to the electrical connector, electrical contacts of the electronic card are pressed respectively against and moved respectively on the contact segments of the electrical connector by a short distance. Due to frictional contact between the electrical contacts of the electronic card and the contact segments of the electrical connector, dust and contaminants can be wiped out from the electrical contacts to increase the reliability of the electrical connection between the electrical connector and the electronic card. However, since the contact segments of the electrical connector lack convex-and-concave structures, the dust and contaminant-wiping effect is not satisfactory.

### SUMMARY OF THE INVENTION

The object of this invention is to provide a manufacturing process that can make a plurality of conductive terminals having improved dust and contaminant-wiping effect.

According to this invention, a manufacturing process for a plurality of conductive terminals comprises the steps of:

(1) punching a flat metallic plate to form a carrier and a plurality of spaced-apart terminal bodies such that an end of each of the terminal bodies is connected to the carrier, and blanking each of the terminal bodies to form an uneven surface, so that the uneven surface serves as a wiping unit;

(2) bending each of the terminal bodies to forma curved contact segment, a resilient segment, a fixed segment, and a connecting segment, such that the uneven surface is located at the contact segment;

(3) assembling the bent terminal bodies to an insulating housing; and

(4) cutting and removing the carrier from the terminal bodies so that the terminal bodies disposed on the insulating housing constitute the conductive terminals.

### BRIEF DESCRIPTION OF THE DRAWINGS

These and other features and advantages of this invention will become apparent in the following detailed description of a preferred embodiment of this invention, with reference to the accompanying drawings, in which:

FIG. 1 is a flow chart of the preferred embodiment of a manufacturing process for a plurality of conductive terminals according to this invention;

FIG. 2 is a schematic top view illustrating a plurality of terminals and a carrier that are formed from a flat metallic plate through a punching operation in the preferred embodiment;

FIG. 3 is a schematic side view illustrating a plate punching and blanking step of the preferred embodiment, including a punching operation performed on the flat metallic plate by a punching die, and a single-stage blanking operation performed after the punching operation by a single blanking die;

FIG. 4 is a schematic side view illustrating a modified plate punching and blanking step of this embodiment, including a punching operation performed on the flat metallic plate by a punching die, and a two-stage blanking operation performed after the punching operation by a single blanking die;

FIG. 5 is a schematic side view illustrating another modified plate punching and blanking step of this embodiment, including a two-stage blanking operation performed by two blanking dies and a punching operation performed after grooves having a V-shaped cross-section are formed in the flat metallic plate by one of the blanking dies;

FIG. 6 is a perspective view of a conductive terminal having an uneven surface that can be formed through any of the punching and blanking operations illustrated by FIGS. 3, 4, and 5, respectively;

FIG. 7 is a fragmentary, exploded perspective view of an insulating housing, the carrier, and the conductive terminals, illustrating a housing assembling step of the preferred embodiment;

FIG. 8 is a perspective view illustrating a first modified uneven surface;

FIG. 9 is a schematic top view illustrating a second modified uneven surface; and

FIG. 10 is a schematic side view illustrating a third modified uneven surface.

### DETAILED DESCRIPTION OF THE PREFERRED EMBODIMENT

Before the present invention is described in greater detail, it should be noted that similar elements and structures are designated by like reference numerals throughout the entire disclosure.

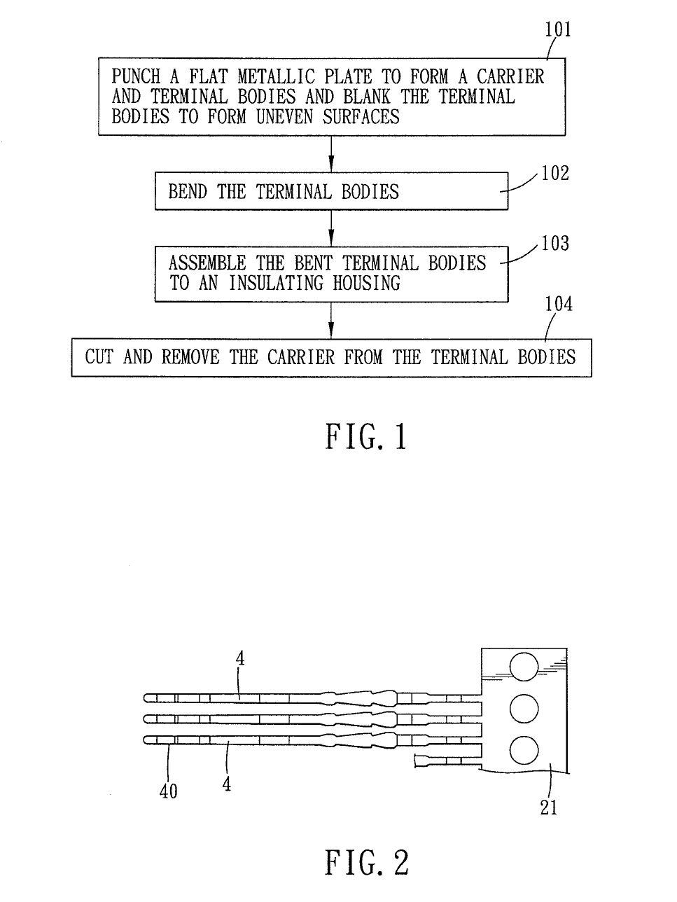

Referring to FIG. 1, the preferred embodiment of a manufacturing process for a plurality of conductive terminals 40 (see FIG. 6) according to this invention includes a plate punching and blanking step 101, a terminal bending step 102, a housing assembling step 103, and a carrier cutting and removing step 104.

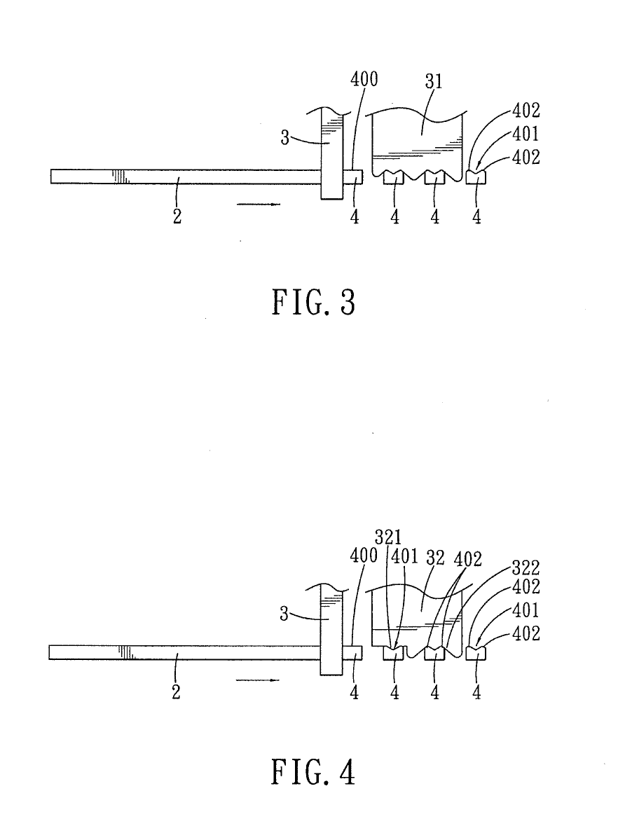

With further reference to FIGS. 2 to 5, in the plate punching and blanking step 101, a flat metallic plate 2 can be punched and blanked by any of processes illustrated in FIGS. 3 to 5 to form a plurality of spaced-apart terminal bodies 4 arranged in a row, and a carrier 21. An end of each of the terminal bodies 4 is connected to the carrier 21. Each of the terminal bodies 4 is blanked to form an uneven surface 411 serving as a wiping unit. The uneven surface 411 of each of the terminal bodies 4 is constructed by forming a longitudinal groove 401 that has a V-shaped cross-section in a flat surface 400 and that extends along a longitudinal direction of the corresponding terminal body 4, and chamfering two opposite side edges of the corresponding terminal body 4 flanking the longitudinal groove 401. As such, after the plate punching and blanking step is performed, each of the terminal bodies 4 is formed with the longitudinal groove 401 and two chamfered side edges 402.

A first punching and blanking process is illustrated in FIG. 3, and includes punching the flat metallic plate 2 by a punching die 3 to form the carrier 21 and the terminal bodies 4, and blanking the terminal bodies 4 by a single blanking die 31 to form the longitudinal grooves 401 and the chamfered side edges 402, such that the terminal bodies 4 are blanked two at a time and each of the terminal bodies 4 is blanked to form the longitudinal groove 401 and the two chamfered side edges 402 simultaneously. As such, in this punching and blanking process, a single-stage blanking operation is preformed individually on the terminal bodies 4.

A second punching and blanking process is illustrated in FIG. 4, and is similar to the first punching and blanking process except that the single-stage blanking operation is replaced with a two-stage blanking operation. The two-stage blanking operation is performed by a single blanking die 32. The blanking die 32 has first and second blanking portions 321, 322. The first blanking portion 321 is used to press against a flat top surface of a terminal body 4, so as to form the longitudinal groove 401 in the flat top surface. The second blanking portion 322 is used to press against a top surface of a terminal body 4 formed with the longitudinal groove 401, so as to form the two chamfered side edges 402. As such, each of the terminal bodies 4 must be subjected to two impacts of the blanking die 32.

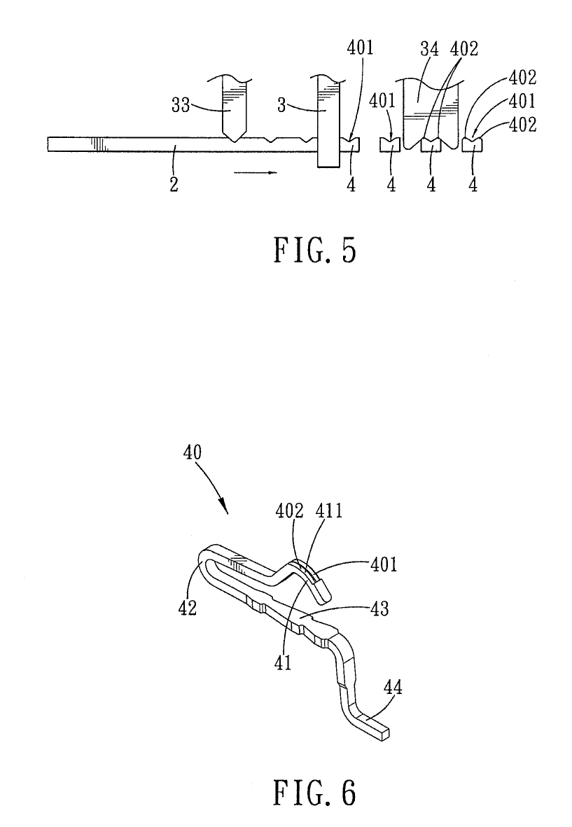

A third punching and pressing process is illustrated in FIG. 5, and includes blanking the flat metallic plate 2 by a first blanking die 33 to forma plurality of parallel longitudinal grooves 401, punching the flat metallic plate 2 by a punching die 3 to form a carrier 21 and a plurality of terminal bodies 4 having the longitudinal grooves 401, respectively, and blanking each of the terminal bodies 4 by a second blanking die 34 to form the two chamfered side edges 402, such that the terminal bodies 4 are blanked one at a time. That is, a two-stage blanking operation is performed on each of the terminal bodies 4.

With further reference to FIG. 6, in the terminal bending step 102, each of the terminal bodies 4 is bent to form a curved contact segment 41, a resilient segment 42, a fixed segment 43, and a connecting segment 44, such that the uneven surface 411 is located at the contact segment 41. The connecting segment 44 is bent from one end of the fixed segment 43. One end of the resilient segment 42 is bent from the other end of the fixed segment 43. The contact segment 41 is bent from the other end of the resilient segment 42.

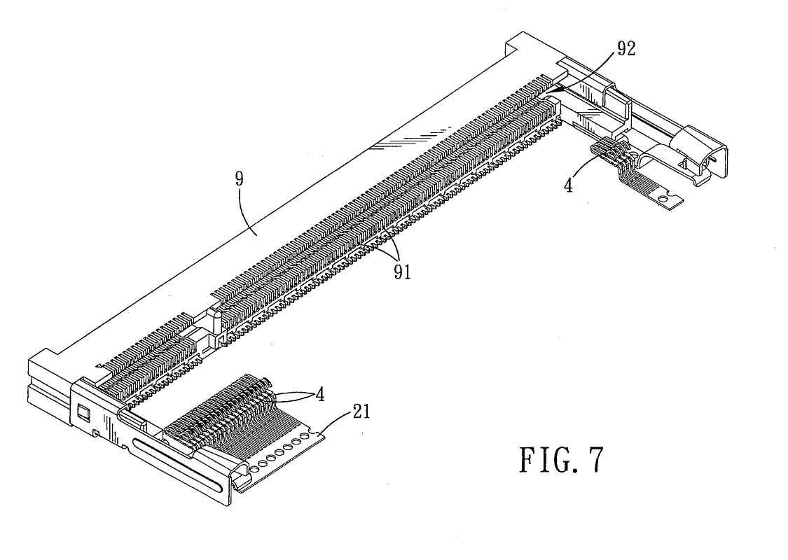

With further reference to FIG. 7, in the housing assembling step 103, the bent terminal bodies 4 are inserted respectively into terminal grooves 91 in an insulating housing 9, such that the contact segments 41 project from a card-receiving slot 92.

In the carrier cutting and removing step 104, the carrier 21 is cut and removed from the terminal bodies 4 to form the conductive terminals 40 on the insulating housing 9.

When an electronic card (not shown) is inserted into the card-receiving slot 92 in the insulating housing 9, electrical contacts of the electronic card are pressed respectively against and moved respectively on the contact segments 41 of the terminals 40. As a result, the uneven surfaces 411 of the terminals 40 serve as wiping units for wiping out dust and contaminants from the electrical contacts of the electronic card, thereby facilitating electrical connection between the electronic card and the electrical connector. Thus, the object of this invention is achieved.

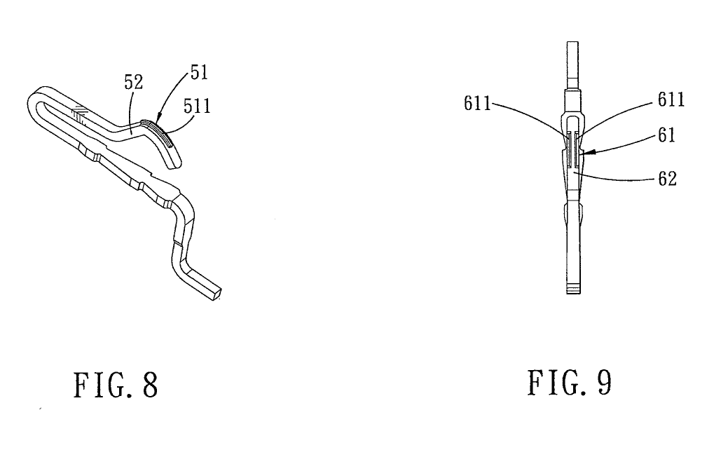

A first modified uneven surface 51 illustrated in FIG. 8 is constructed by forming a rib 511 on a top surface of the contact segment 52. The rib 511 extends along a longitudinal direction of the contact segment 52. That is, in the plate punching and blanking step 1, the rib 511 extends along a longitudinal direction of the corresponding terminal body 4. The rib 511 can contact frictionally an electrical contact of the electronic card to wipe out dust and contaminants from the same.

A second modified uneven surface 61 illustrated in FIG. 9 is a grooved surface, and is constructed by forming two spaced-apart parallel longitudinal grooves 611 in two opposite side edges of the contact segment 62. Each of the longitudinal grooves 611 extends along a longitudinal direction of the contact segment 62. That is, in the plate punching and blanking step 1, each of the longitudinal grooves 611 extends along a longitudinal direction of the corresponding terminal body 4. As such, since frictional contact between an electrical contact of the electronic card and a top surface of the contact segment 62 located between the longitudinal grooves 611 occurs when the electronic card is inserted into the electrical connector, dust and contaminants can be wiped out from the electrical contact of the electronic card.

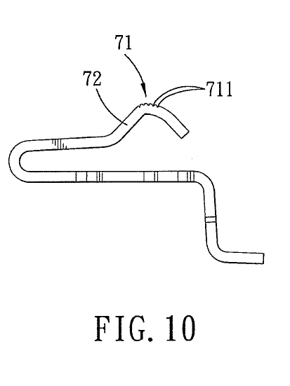

A third modified uneven surface 71 illustrated in FIG. 10 is a grooved surface and that is constructed by forming a plurality of transverse grooves 711 in a top surface of the contact segment 72. Each of the transverse grooves 711 extends along a transverse direction of the contact segment 72. That is, in the plate punching and blanking step 101, each of the transverse grooves 711 extends along a transverse direction of the corresponding terminal body 4.

With this invention thus explained, it is apparent that numerous modifications and variations can be made without departing from the scope and spirit of this invention. It is therefore intended that this invention be limited only as indicated by the appended claims.

We claim:

1. A manufacturing process for a plurality of conductive terminals, comprising the steps of:
(1) punching a flat metallic plate to form a carrier and a plurality of spaced-apart terminal bodies such that an end of each of the terminal bodies is connected to the carrier, and blanking each of the terminal bodies to form an uneven surface, so that the uneven surface serves as a wiping unit;
(2) bending each of the terminal bodies to form a curved contact segment, a resilient segment, a fixed segment, and a connecting segment, such that the uneven surface is located at the contact segment;
(3) assembling the bent terminal bodies to an insulating housing; and
(4) cutting and removing the carrier from the terminal bodies so that the terminal bodies disposed on the insulating housing constitute the conductive terminals.

2. The manufacturing process as claimed in claim 1, wherein, in said step (2), the uneven surface of each of the terminal bodies is a grooved surface.

3. The manufacturing process as claimed in claim 2, wherein, in said step (2), the uneven surface is constructed by forming a longitudinal groove having a V-shaped cross-section in a flat surface of each of the terminal bodies, and chamfering two opposite side edges of each of said terminal bodies flanking the longitudinal groove.

4. The manufacturing process as claimed in claim 2, wherein, in said step (2), the uneven surface is constructed by forming two spaced-apart parallel longitudinal grooves in two opposite side edges of each of the terminal bodies, each of the longitudinal grooves extending along a longitudinal direction of a corresponding one of the terminal bodies.

5. The manufacturing process as claimed in claim 1, wherein, in said step (2), the uneven surface is constructed by forming a rib on a flat surface of each of the terminal bodies, the rib of each of the terminal bodies extending along a longitudinal direction of a corresponding one of the terminal bodies.

6. The manufacturing process as claimed in claim 1, wherein, in said step (2), the uneven surface is constructed by forming a plurality of spaced-apart transverse grooves in a flat surface of each of the terminal bodies, each of the transverse grooves extending along a transverse direction of a corresponding one of the terminal bodies.

7. An electrical connector adapted for electrical connection with an electronic card, said electrical connector including a plurality of conductive terminals, each of said terminals being bent and having a fixed segment, a connecting segment bent from one end of said fixed segment, a resilient segment bent from the other end of said fixed segment at one end thereof, and a contact segment bent from the other end of said resilient segment and having an uneven surface that serves as a wiping unit and that is adapted to move over the electronic card to wipe out dust and contaminants from the electronic card when the electronic card is assembled to said electrical connector.

8. The electrical connector as claimed in claim 7, wherein said uneven surface of each of said terminals is formed with a rib that extends along a longitudinal direction of said contact segment of a corresponding one of said terminals.

9. The electrical connector as claimed in claim 7, wherein said uneven surface of each of said terminals is formed with two spaced-apart parallel longitudinal grooves in two opposite side edges of a corresponding one of said terminals, each of said longitudinal grooves extending along a longitudinal direction of said contact segment of a corresponding one of said terminals.

10. The electrical connector as claimed in claim 7, wherein said uneven surface of each of said terminals is formed with a longitudinal groove that has a V-shaped cross-section, and each of said terminals has two opposite chamfered side edges flanking said longitudinal groove in a corresponding one of said terminals.

11. The electrical connector as claimed in claim 7, wherein said uneven surface of each of said terminals is formed with a plurality of spaced-apart transverse grooves each extending along a transverse direction of said contact segment of a corresponding one of said terminals.
